(19) United States
(12) Patent Application Publication
(10) Pub. No.: US 2004/0061257 A1
(43) Pub. Date: Apr. 1, 2004

(54) Packaging technique for elastomeric microfluidic chips and microfluidic device prepared thereby

(75) Inventors: Jens-Christian D. Meiners, Saline, MI (US); Dhruv Acharya, Ann Arbor, MI (US)

Correspondence Address: BROOKS KUSHMAN P.C., 1000 TOWN CENTER, TWENTY-SECOND FLOOR, SOUTHFIELD, MI, 48075, US

(73) Assignee: The Regents of the University of Michigan, Ann Arbor, MI

(21) Appl. No.: 10/672,254

(22) Filed: Sep. 26, 2003

Related U.S. Application Data
(60) Provisional application No. 60/414,257, filed on Sep. 27, 2002.

(51) Int. Cl. B29B 13/00

(52) U.S. Cl. 264/271.1

(57) ABSTRACT

A robust microfluidics device is prepared by encapsulating a cast elastomer containing one or more microfluidic passages, and associated with at least one interconnect, onto a substrate employing as an encapsulating resin a curable resin which exhibits volume contraction upon cure.

### CROSS-REFERENCE TO RELATED APPLICATIONS

This application claims the benefit of U.S. provisional application Serial No. 60/414,257 filed Sep. 27, 2002.

### BACKGROUND OF THE INVENTION

1. Field of the Invention

The present invention pertains to microfluidic chips having one or more microfluidic passages therein.

2. Description of the Related Art

Microfluidic devices are in widespread use. Such devices are generally of rather small size, and contain one or more microfluidic passages. The passages may be used for liquid atomization by gas flow, as micro flow cytometer cells, as zones for monitoring chemical reactions on a very small scale, for cell growth, for analytical techniques employing monoclonal antibodies, and for a myriad of other uses where relatively small volumes of liquid and/or gas are involved. Such devices are well known, and many literature articles describe their construction and use. The use of such devices for DNA analysis, for example, is disclosed by M. A. Burns, et al. “Microfabricated Structures for Integrated DNA Analysis,” PROCEDURES OF THE NATIONAL ACADEMY OF SCIENCES, 1996, 93, pp. 5556-61. See, also S. Takayama, “Chemoenzymatic Preparation of Novel Cyclic Imine Sugars and Rapid Biological Activity Evaluation Using Electrospray Mass Spectometry and Kinetic Analysis,” J. AM. CHEM. SOC., 119, pp. 8146-51 (1997).

Many microfluidic devices are prepared from cast elastomers. The casting process is relatively simple, and a single mold may be reused many times. The use of elastomers in the casting process has the advantage that relatively complex channel structures may be created, even involving undercuts, due to the flexibility of the elastomer. Elastomer flexibility may also be exploited in configuring the devices with active components such as pinch-type valves which rely on the distortability of the elastomer to pinch-off fluid or gas passages. Valves such as these are reported by Y. N. Xia, et al., SCIENCE, v. 273, p. 347 ff (1996) (soft lithography); Y. N. Xia, et al., “Soft Lithography,” ANNU. REV. MATTER SCI., v. 28, pp. 153-184 (1998); D. C. Duffy, et al., “Rapid Prototyping of Microfluidic Systems in Poly(dimethylsiloxane),” ANALYTICAL CHEMISTRY, 1998, 70, pp. 474-84.

While numerous elastomers may be used for such processes, for example epoxy resin elastomers, polyurethane elastomers, polyester elastomers, etc., the predominant elastomers are organopolysiloxane elastomers. Use of such elastomers is reported by the references cited above, which are herein incorporated by reference.

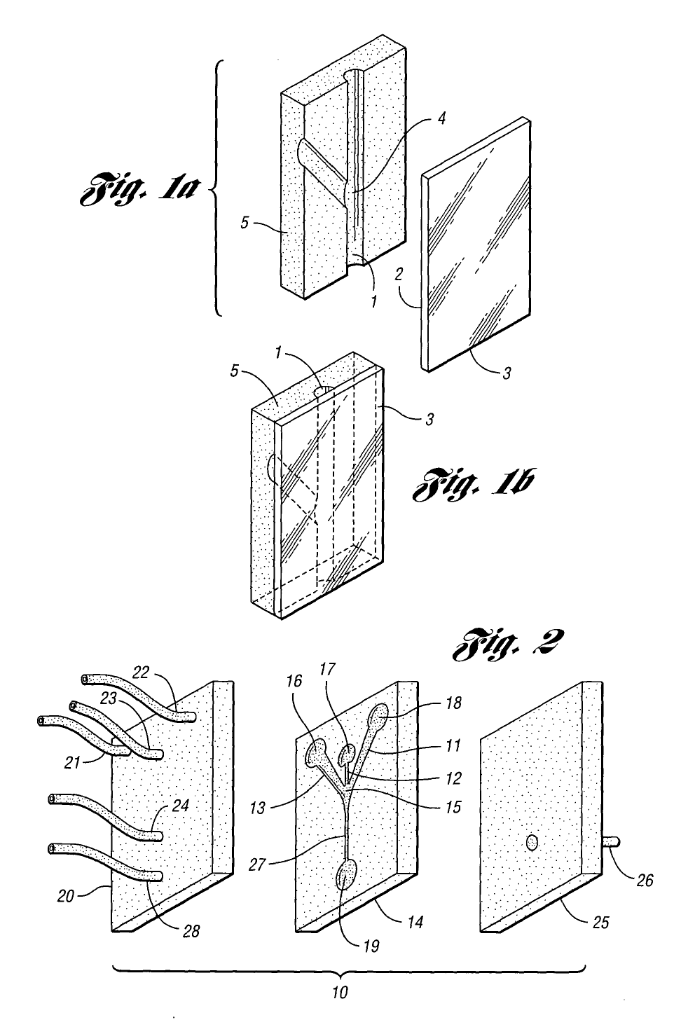

Due to the necessity to contain fluid passages, sandwich structures are often required. For example, fluid passages may be created in the surface of an elastomer layer, this layer then being bonded to a glass substrate. The fluid passage walls will then be comprised of the glass surface and the elastomer (surfaces). Such a structure is shown in FIG. 1, where the channel 1 is bounded by the surface 2 of substrate 3 and the interior walls 4 of elastomer 5. The substrate surface, in this case glass, will often be chemically or biochemically modified, rather than the elastomer passage walls.

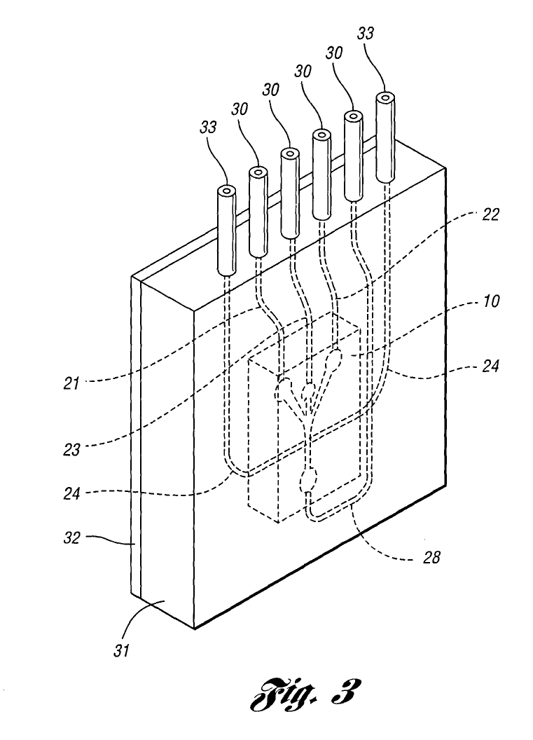

It is also common to have multi-layer sandwich structures where all or part of the fluid passages are within and between elastomer layers. A typical two dimensional focusing flow cell is illustrated in FIGS. 2 and 3. In FIG. 2, a three piece embodiment of a flow cell 10 is depicted. The flow channels 11, 12, and 13 are contained in the middle layer 14, and supply focusing gas through channels 11 and 13, and sample liquid through channel 12, to the focusing zone 15. At the top of each channel is located an optional supply reservoir (16, 17, 18), generally of larger size to simplify connective pathways for supply of the various fluids and to stabilize fluid dynamic behavior at the channel inlets. Following the focusing zone 15 is an outlet reservoir 19. Leftmost layer 20 contains gas inlets 21 and 22 which are in communication, following assembly of the flow cell, with gas supply reservoirs 16, 18, respectively. It is also possible, and preferred, to use but one gas inlet which communicates with all gas supply reservoirs, or directly with the gas channels should reservoirs or equivalent structure be absent. Leftmost layer 20 also contains a sample inlet 23 in fluid communication with sample reservoir 17 and or channel 12. Also included is light source connector or supply 24, as more fully described hereafter. Rightmost layer 25 is a transparent rigid substrate, for example of glass. The focusing zone 15 transitions to interrogation zone 27, aligned between connector or light source 24 and the transparent substrate. Thus, layer 20 will require multiple connections to external liquid and gas lines, typically of very fine diameter tubing, in this case illustrated as having been embedded into layer 20 during casting. FIG. 3 is discussed below.

While such microfluidic devices have been used for some time, their construction has been problematic. The elastomer layers tend to be relatively fragile, and due to their elastomeric nature, are not ideal materials to embed small tubing required for supply and exit of fluids. In many devices, the flow rate is critical, and may change when even minor stress is exerted on the tubing. Other attached components such as optical fibers used for a variety of detection methods may have their physical properties changed as a result of such stress as well.

Moreover, many such devices require transparency to enable observation of the fluid passages by microscopy, spectroscopic detectors, etc. To bond the elastomer to the glass substrate, baking is often employed. The baking procedure is often associated with outgassing from the elastomer, which can alter the surface chemistry of passage walls in an undesirable and often unpredictable manner, particularly passage walls formed by the substrate.

In addition to these drawbacks, such microfluidic devices tend to be quite fragile, and must be handled carefully to avoid damage to the device or the interconnects.

It would be desirable to provide a method for the fabrication of elastomeric microfluidic which does not require baking, and which provides a robust structure wherein interconnects with the device passages or of monitoring devices such as optical fibers and the like are rendered resistant to distortion by stresses imposed on the device or interconnects.

### SUMMARY OF THE INVENTION

It has now been surprisingly discovered that elastomeric microfluidic devices containing at least one elastomeric portion on a rigid substrate, and having at least one interconnect, can be prepared as a robust structure without a baking step by employing a curable resin encapsulant which exhibits volume contraction upon cure to encapsulate an elastomeric portion of the microfluidic device against the substrate and to encapsulate portions of the interconnects extending from the elastomeric portion of the device.

### DETAILED DESCRIPTION OF THE DRAWINGS

FIG. 1 illustrates a microfluidics device comprised of an elastomeric portion and a glass substrate, having microfluidic passages defined therebetween;

FIG. 2 illustrates a microfluidic gas focusing flow cytometer with attached supply and receiving tubing;

FIG. 3 illustrates a flow cytometer of the type of FIG. 2 encapsulated in accordance with the subject invention and having plug-type connectors;

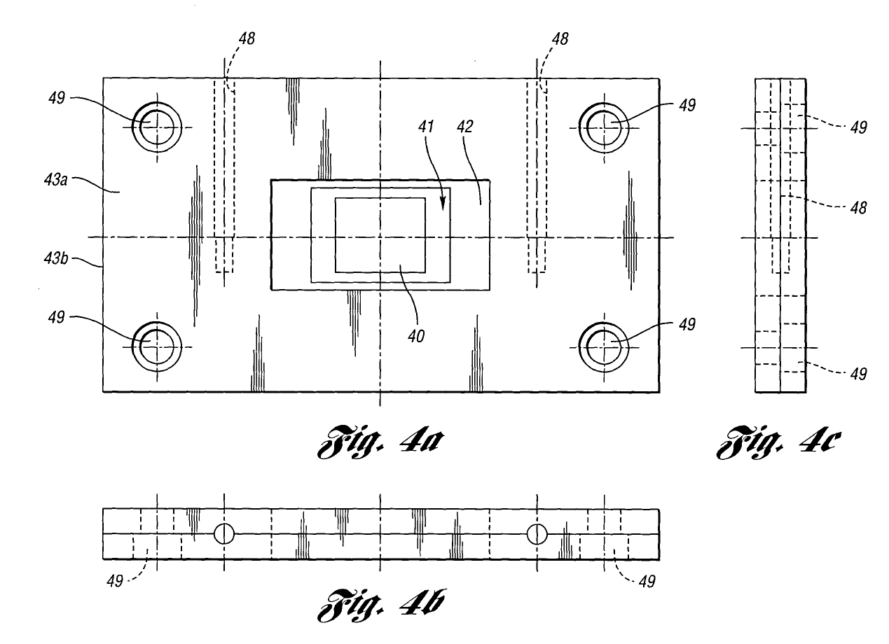

FIG. 4 illustrates views of a frame suitable for use in encapsulating a microfluidics device;

FIG. 5 is a side view of the frame of FIG. 4 illustrating the encapsulating process; and

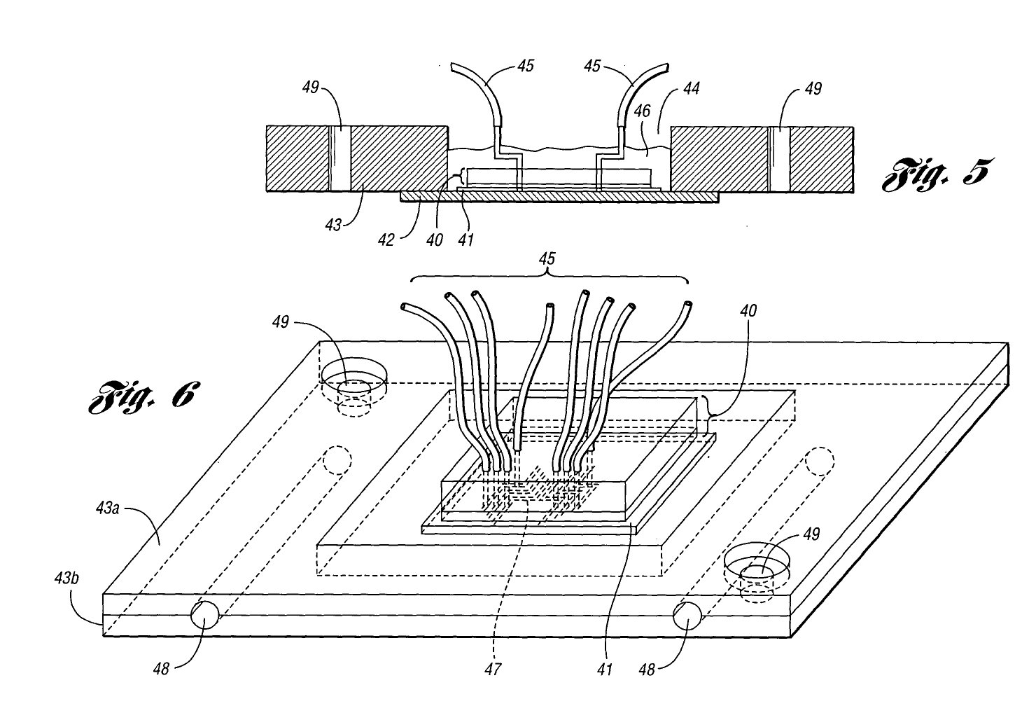

FIG. 6 is a further embodiment of the frame and encapsulation method of FIGS. 4 and 5.

### DETAILED DESCRIPTION OF THE PREFERRED EMBODIMENTS

The devices of the subject invention include at least one elastomeric portion, generally in the form of a flat layer or slab, mounted on a rigid substrate. Between the substrate and the adjacent elastomeric portion, or within the elastomeric portion, are contained at least one microfluidic chamber “or passage” which requires connection to an outside source of fluid, or at least one monitoring device which is embedded into, connected with, or associated with a passage or to a monitoring device associated with the elastomeric portion of the device.

For example, the microfluidic device may contain a gravity-driven pump comprising a relatively large fluid-filled supply chamber, an electromagnetically-operated or pressure activated microvalve to initiate flow from the supply chamber, a microchannel through which the fluid flows, and a receiving chamber to receive fluid from the microchannel. The microchannel may be flanked by optical waveguides, for example fiber optic “cables” to illuminate the microchannel and observe light-absorbed, transmitted, scattered, etc., by materials passing through the microchannel. For example, microbes tagged with fluorescing substances may be illuminated by one optical fiber, and fluorescence monitored by a further optical fiber. Such a monitoring method may be used to detect microbe passage through the channel. It is desirable that the fiber optic “cables” be firmly anchored, such that stress will not induce artifacts which might alter the sensitivity of the device. By embedding the device with curable resin in accordance with the present invention, the fiber optic cables will be firmly anchored, and thus stress-induced changes in sensitivity will be minimized. In devices such as this, no fluid interconnects are present.

More usually, the devices of the subject invention will include at least one and generally two or more fluid interconnects in the form of very fine tubing. The tubing may be of glass, polymer or metal. Polymer (plastic) tubing is generally used. Such fluid interconnects are used to supply liquids and gases to the microfluidic device, and generally to provide an outlet stream from the device as well. For example, a relatively simple liquid focusing flow cytometer will contain at least one and generally two or more focusing fluid supply interconnects, a sample fluid interconnect, and an outlet fluid interconnect. Flow cytometers which rely on optical fibers for monitoring flow through the observation channel of such devices may also contain from one to six or more optical fibers terminating at or near the observation channel. It is important that at least the fluid interconnects and preferably all interconnects are immobilized. Encapsulation by the process of the present invention achieves this result.

The substrate is a relatively rigid material which may be selected in view of the mechanical and optical properties desired. For example, the substrate may be of metal, glass, fused silica, quartz, sapphire, silicon, or a variety of plastic materials, including without limitation thermoset and thermoplastic polymers such as polystyrene, polyvinylchloride, polyethylene, polypropylene, epoxy, polyurethane, etc. The substrate is rigid in the conventional sense, i.e., is not “rubbery.” Glass is the preferred substrate, often in the form of a “cover slip” as may be used in optical microscopy. Use of transparent substrates facilitates observation of the fluid passages of the device by means of light, for example microscopy or spectroscopic observation.

The elastomer of which the elastomeric portion containing or defining at least a portion of the fluid passages may be any suitable castable elastomer. Examples of castable elastomers include elastomeric epoxy resins, two component polyurethane elastomers, elastomeric unsaturated polyester resins, and the like. However, the preferred castable elastomers are room temperature vulcanizable silicone elastomers, either one component (RTV-1) or two component (RTV-2). Such silicone elastomers may be curable by any conventional curing mechanism, i.e., condensation curable, peroxide curable, or addition curable. Suitable castable elastomers are available from numerous sources. Castable elastomers which cure to a transparent solid are generally required, due to the necessity of monitoring performance within the device by optical means. However, in the case where a device has an integral microfluidic flow meter incorporated therein, the elastomer may then be made of opaque material. A preferred elastomer is RTV 615 silicone elastomer composition available from General Electric Silicones.

In general, multiple layers of cast elastomer are used to provide the flow channels, mixing chambers, supply reservoirs, and other microfluidic passages, these layers being stacked together. The fluid passages are generally formed at the juncture of two layers or within a layer flanked by additional layers. Fluid passages may also be formed at the juncture of the substrate and the adjacent elastomeric layer or layers. The various elastomer layers may be “baked” or cured at elevated temperature prior to positioning on the substrate.

The interconnects are attached to the device by insertion into the cast device, either prior to or subsequent to assembly of the various layers, or may be positioned prior to casting the elastomer. These methods of fabrication of substrate, elastomer layer(s), and positioning of interconnects are all well known to those skilled in the art. By “interconnect” is meant a tube, wire, cable, optical fiber, etc., which is used to supply fluid to or receive fluid from the device, or through which a monitoring signal is passed or capable of being passed. Thus, interconnects include both gas and liquid supply and receiving tubing as well as optical waveguides, including fiber optics. The term also includes electrical wires and the like which supply electrical energy to activate on-board pumps, valves, mixing devices, capacitive sensors, and the like. This definition of “interconnects” should not be construed as limiting, unless indicated otherwise.

The encapsulating resin is a curable resin, i.e., a thermosettable resin, which, as it cures, exhibits volume contraction. Determination of volume contraction is easily made by comparing the volume of the resin in the uncured condition with the volume in the cured condition. A resin which has the same or larger volume in the cured state as compared to the uncured state will not achieve the benefits of the invention. Preferably, the encapsulating resin is a transparent resin, most preferably a transparent epoxy resin. Such resins are commercially available. A preferred resin is Tra-Bond 2115 available from Tra-Con, Inc., which has suitable optical properties and only slight volume contraction. When the microfluidic passages are formed between a glass substrate and an elastomeric device, monitoring techniques such as epi-fluorescence may be used, and the encapsulating resin may be opaque.

The devices of the subject invention are fabricated by positioning the various elastomeric layers into the substrate as in conventional fabrication, followed by pouring the encapsulating resin such that the elastomeric layers are surrounded by the encapsulant on all sides where interconnects are present. Preferably, the entire device is encapsulated. As the encapsulant cures, it shrinks, pressing the various layers together and against the substrate, and encapsulates the interconnects at the same time. Due to the pressure exerted by the curing resin, baking to adhere the elastomer to the substrate is avoided. While not required by the present invention, the contracting adhesion may also secure the various elastomeric layers when two or more of the latter are used, rather than “baking” these layers together.

In a preferred embodiment, the elastomer portions of the microfluidic device are assembled onto a glass substrate and introduced into a cavity in a holder, preferably a two-part metal holder. The holder may have a cavity with a lip onto which the glass substrate rests, but in the most preferred embodiment, the cavity is temporarily closed off at the bottom by means of an adhesive tape. Other means are also suitable, for example a clamped-on piece of metal or plastic such as a mylar film, or a polyethylene or polytetrafluoroethylene sheet, or the like. The holder may also be constructed of materials other than metal, for example plastics material.

Following attachment of the interconnects, if not already attached, the encapsulant is introduced into the cavity. Following curing of the encapsulant, the temporary bottom cover, i.e., adhesive tape, is removed. The device remains supported by the metal frame.

The metal frame may be of one or multiple parts. Preferably, a two-part construction is used such that the frame may be separated from the encapsulated microfluidic device and reused. Thus, for example as shown in the Figure, the frame may be of two halves secured together by screws or bolts or by other fastening devices. The frame may also have appropriate positioning locators, or holes and/or threads suitable for mounting the frame onto a microscope translation stage or microarray reader.

In a preferred configuration, the interconnects comprise or are terminated by rigid metal or plastic tubing or metal or plastic fittings in a defined configuration, such that the device may be “plugged into” a module having correspondingly configured fluid supply passages. If optical waveguides are also involved, the interconnects may also be configured for there to be “plug-ins” as well, although separate connections may be desirable in some or many applications.

For example, the interconnects may be composed entirely of metal tubing which is inserted into or cast into the elastomer or between the elastomer and the substrate, optionally with the aid of sealants, adhesives, etc. Alternatively, the interconnects may be provided on the device side by typical polymer tubing, this polymer tubing then attached to metal tubing or suitable fittings, as previously described. The assembly, of whichever type, is encapsulated by resin. The tubing may protrude to any convenient length, preferably about 0.4 inch (10 mm).

The devices of this preferred embodiment may take numerous forms, such as an embodiment having all interconnects on one face of the device or on one edge of the device, or may be configured in the manner of an electronic device package known as “DIP” (dual in-line package). Thus, the configuration is designed to be compatible with a similarly configured fluid supply and/or monitoring module, such that the microfluidics devices may be inserted and removed easily. Standards for positioning of various interconnects may be appropriate.

In FIG. 3, an elastomeric flow cytometer of the type shown in FIG. 2 has its various interconnects 21, 22, 23, 24, and 28 connected to short metal tubing 30, and encapsulated in epoxy resin 31 which, due to volume contraction, presses the elastomeric flow cytometer body 10 against a rigid substrate 32. If the rigid substrate 32 is glass and the epoxy optically transparent, the observation or “interrogation” zone (27 in FIG. 2) may be monitored by optical means through these portions of the device. The device shown in FIG. 3 also has fiber optic strands 24 embedded in the cytometer cell 10 which terminate proximate the interrogation zone. These extend to metal tubing 33 which may be different than the other metal tubing (30) in being configured specifically for fiber optic connection. Thus, the tubing 33 may contain a microlens system to facilitate connection of the optical fibers to suitable light supply and monitoring apparatus.

FIGS. 4-7 illustrate the encapsulation of elastomeric microfluidics devices into a suitable frame. A suitable frame 43 is shown in three views in FIG. 4. In FIGS. 4 and 5, a multilayer elastomer chip 40 is shown positioned onto a cover slip 41 which is in turn adhesively fixed to tape 42 covering the opening or “well” 44 in the frame of FIG. 4. The microfluidics tubing is shown extending into the elastomer, and the entire assembly filled with epoxy encapsulating resin 46. After curing, the tape will be removed. FIG. 6 illustrates encapsulation of a more complex device with multiple supply/exit tubes, the internal microfluidic channels 47 being shown also. The frame is desirably in two parts, 43a and 43b, held together by threaded fasteners (not shown) which are inserted into holes 48. The frame also desirably contains mounting holes 49 to enable attachment to a use station, microscope stage, etc.

The metal frame may often be dispensed with depending upon the end use and manipulation envisioned. For example, chips with extending pin connectors such as those of FIG. 3 may be retained in the frame when mounted on an inverted microscope, whereas removal of the frame facilitated ease of use with an upright microscope. It should be noted that while FIG. 3 illustrates connectors exiting from only one edge of the device, these connectors may emanate from multiple edges, or from the faces as well, or any combination. The location of the connectors is a very flexible design choice.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for the preparation of a robust microfluidics device having at least one interconnect, comprising:
positioning at least one elastomeric portion onto a rigid substrate, said elastomeric portion containing, or said elastomeric portion defining together with said substrate, at least one fluid passage;
providing at least one interconnect to said elastomeric portion;
encapsulating said elastomeric portion(s) and said interconnect(s) with a curable resin which exhibits volumetric contraction upon curing, said resin surrounding said elastomer portion and at least a portion of said substrate; and
curing said curable resin to provide an encapsulated microfluidics device, whereby said curable resin presses said elastomeric portion against said substrate.

2. The process of claim 1 wherein said substrate is glass.

3. The process of claim 1 wherein said interconnect is a fluid supply tubing or fluid receiving tubing.

4. The process of claim 1 wherein said interconnect is a fiber optical cable.

5. The process of claim 1 wherein at least two fluid supply and/or fluid receiving tubing interconnects are present.

6. The process of claim 1 wherein said encapsulating resin is a transparent resin.

7. The process of claim 1 wherein said encapsulating resin is an epoxy resin.

8. The process of claim 1 wherein said substrate and said elastomeric portions are located within a cavity in a frame, and said encapsulating resin is introduced into said cavity.

9. The process of claim 8 wherein said frame is a two-part frame.

10. A microfluidics device prepared by the process of claim 1.

11. A microfluidics device prepared by the process of claim 2.

12. A microfluidics device prepared by the process of claim 3.

13. A microfluidics device prepared by the process of claim 4.

14. A microfluidics device prepared by the process of claim 5.

15. A microfluidics device prepared by the process of claim 6.

16. A microfluidics device prepared by the process of claim 7.

17. A microfluidics device prepared by the process of claim 8.

18. A microfluidics device prepared by the process of claim 9.

19. A microfluidics device prepared by the process of claim 1, wherein metal tubing interconnects which protrude from the encapsulated device in a defined configuration adapted to be inserted into correspondingly configured fluid supply lines are in fluid communication with one or more microfluidic passages in said device.
